(19) United States
(12) Patent Application Publication
(10) Pub. No.: US 2010/0155356 A1
(43) Pub. Date: Jun. 24, 2010

(54) PROFILE SHAPE FOR A CRANE BOOM

(76) Inventor: Eckhard WIMMER, Hallein (AT)

Correspondence Address: WENDEROTH, LIND & PONACK, L.L.P., 1030 15th Street, N.W.,, Suite 400 East, Washington, DC, 20005-1503, US

(21) Appl. No.: 12/718,314

(22) Filed: Mar. 5, 2010

Related U.S. Application Data
(63) Continuation of application No. PCT/AT2008/000309, filed on Aug. 29, 2008.

(30) Foreign Application Priority Data
Sep. 5, 2007 (AT) GM 528/2007

(51) Int. Cl. B66C 23/42

(52) U.S. Cl. 212/300

(57) ABSTRACT

The invention relates to a crane jib for a crane, having a longitudinal axis and an imaginary contour line that extends in a transversal plane relative to an axis of symmetry in an at least approximately mirror-symmetric manner, the contour line having an at least approximately arcuate section between a center that is equally interspaced from the first and second point of intersection on the axis of symmetry and the first point of intersection, a first straight section being tangentially contiguous thereto in the direction of the second point of intersection, the imaginary extension of which first straight section in the direction of the second point of intersection intersects the axis of symmetry and forms an acute angle therewith. The invention is characterized in that a second straight section is tangentially contiguous to the approximately arcuate section in the direction of the first point of intersection and extends up to the axis of symmetry and forms an angle of less than 90 degree with said axis of symmetry in the first point of intersection in the interior of the surface enclosed by the contour line.

The present invention concerns a crane boom for a crane having a longitudinal axis and a contour line extending in a transverse plane relative to an axis of symmetry in mirror-symmetrical relationship, wherein the contour line has between a point arranged on the axis of symmetry equidistantly relative to the first and second intersection points and the first intersection point an at least approximately arcuate portion which is tangentially adjoined in the direction of the second intersection point by a first straight portion whose notional extension in the direction of the second intersection point intersects the axis of symmetry and includes an acute angle therewith.

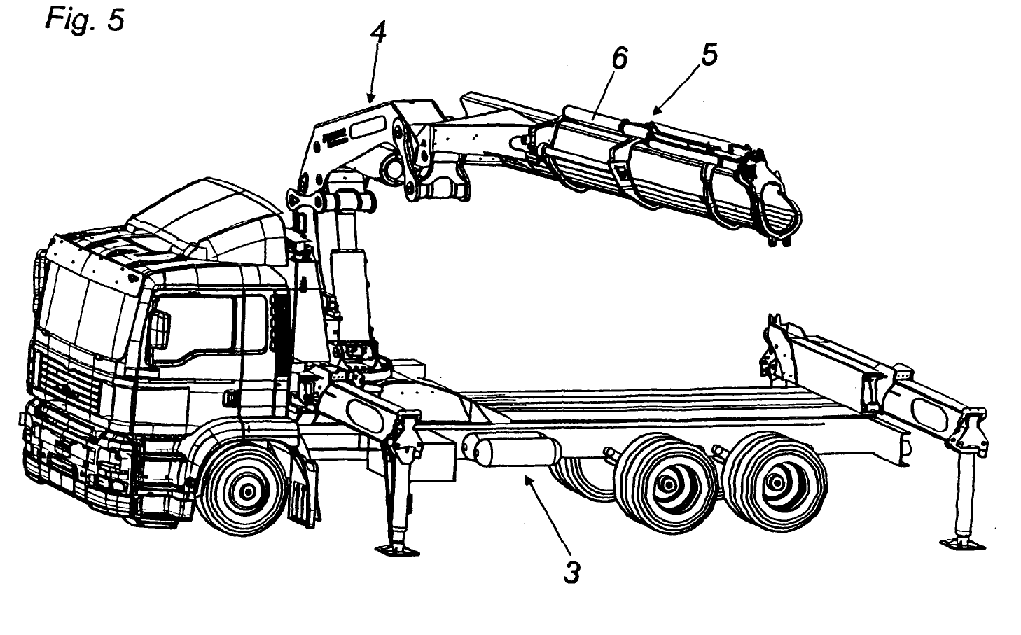

Such a crane boom is shown for example in FIG. 13 of EP 583 552 B1.

A disadvantage is that production of the arcuate portion is complicated and expensive and cannot be easily carried out in an error-free manner.

The object of the invention is to provide an improved crane boom.

That object is attained by a crane boom having the features of claim 1.

It will be appreciated that a real crane arm has both an outside contour and an inside contour by virtue of the material thickness of the components forming it. The ‘notional contour line’ refers to the outside contour of the crane boom.

The invention affords good weldability of the crane boom, better suitability for clamping for the welding operation by virtue of the portions which meet each other inclinedly and the implementation of a longitudinal weld seam without additional edge preparation. Overall that affords a configuration which is more reliable in terms of process implementation.

Further advantageous embodiments are defined in the appendant claims.

The term centroid is used in the context of this disclosure to denote the center of gravity of the overall region enclosed by the notional contour line. The term ‘centroid’ is therefore not to be interpreted in relation to the area enclosed between the outside and inside contours.

The invention further concerns a jib system for a crane, wherein at least one jib and/or jib extension is in the form of a crane boom as set forth in one of claims 1 through 17. Preferably there are provided between one and twenty, preferably between five or ten, jib extensions. It is particularly preferable for more than five jib extensions to be provided.

The invention further concerns a crane, in particular a loading crane, having a crane boom according to one of the aforementioned embodiments or a jib system of the aforementioned kind as well as a utility vehicle equipped with such a crane.

Further advantages and details of the invention will be apparent from the Figures and the related specific description. In the Figures:

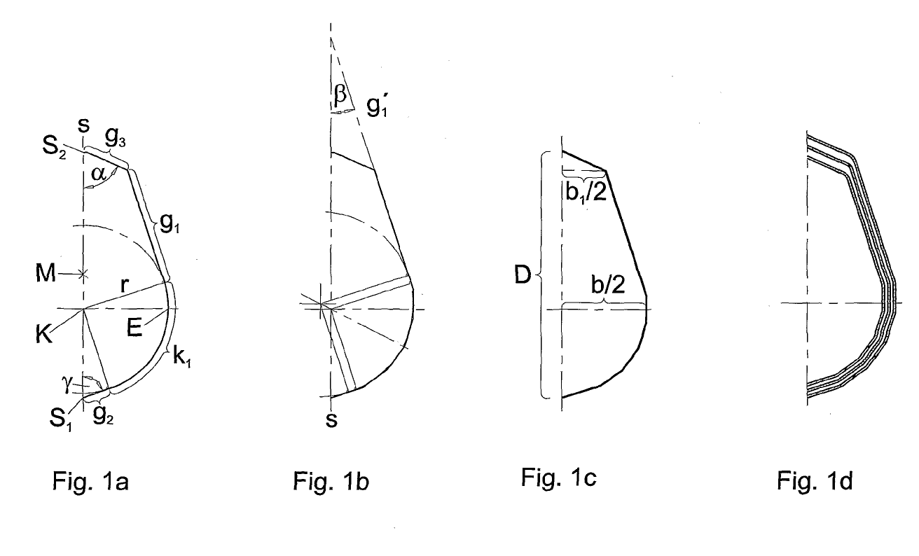

FIG. 1a shows a first embodiment of the notional contour line of a crane boom according to the invention,

FIGS. 1b and 1c show the construction of a contour line (FIG. 1b) and the corresponding sheet metal structure (FIG. 1c) of an embodiment in which the arcuate portion k₁ is approximated by a polygonal line,

FIG. 1d shows a jib system having three jib extensions as shown in FIG. 1b,

FIG. 1e shows the crane boom of FIGS. 1a through 1c, showing the position of the centroid,

FIG. 1f shows a jib system having a jib extension, showing the arrangement of mounting elements,

FIG. 1g shows a jib system with a jib extension, wherein the arcuate portion in the jib and the jib extension was approximated by different polygons,

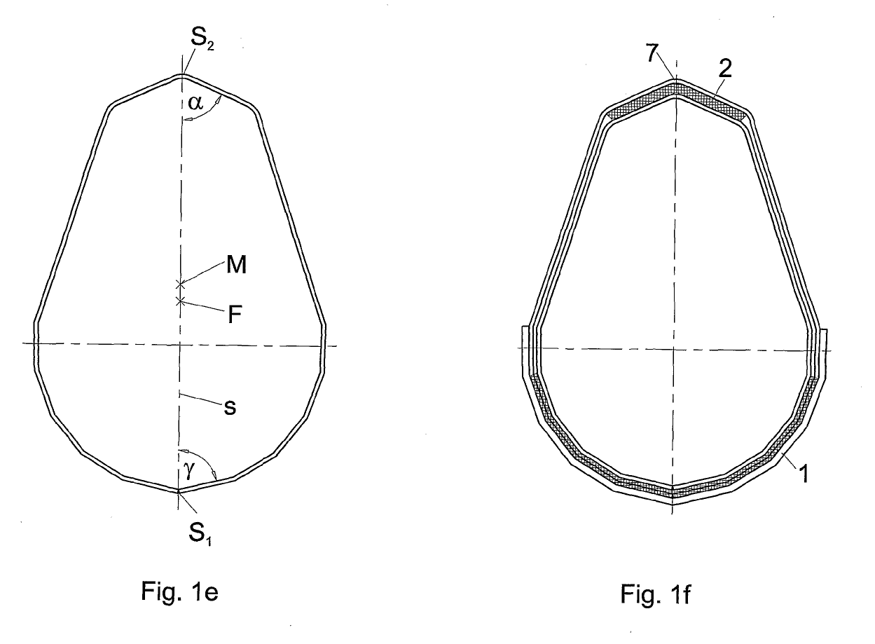

FIG. 2 shows the crane boom of FIGS. 1a through 1c and 1e, wherein that area to which the centroid relates has been shown in dash-dotted lines representatively for all embodiments,

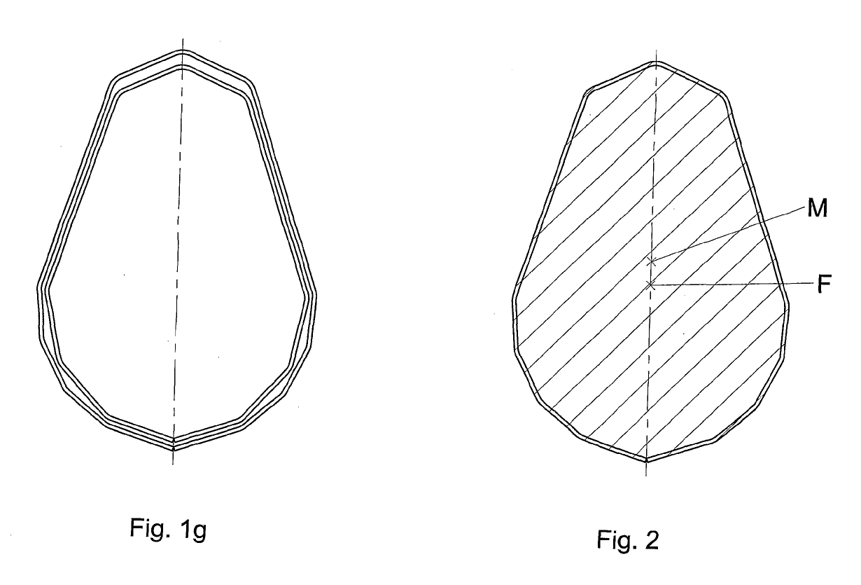

FIG. 3 shows a second embodiment of the notional contour line of a crane boom according to the invention,

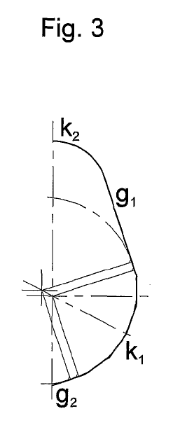

FIG. 4 shows a perspective view of a jib system as shown in FIG. 1d, and

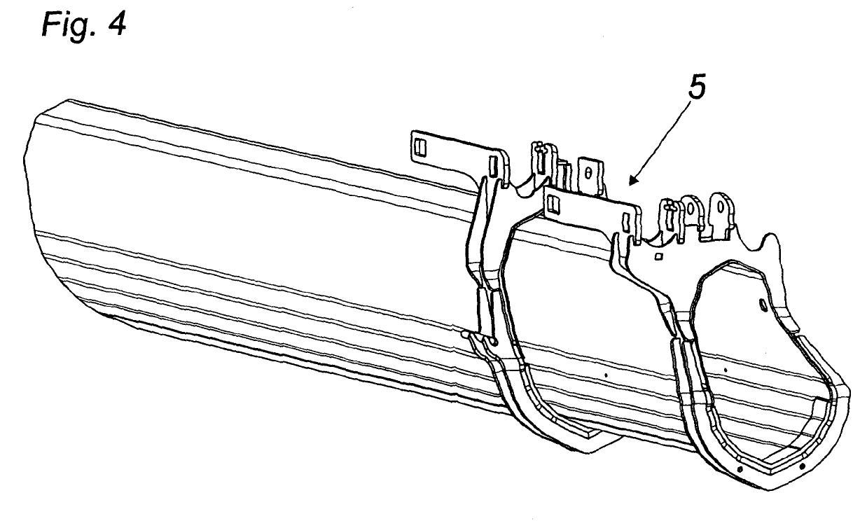

FIG. 5 shows a utility vehicle with a crane according to the invention.

It will be presupposed that all Figures are true to scale insofar as the lengths of the individual contour portions and the illustrated angles are shown in the correct ratio to each other. All angle references relate to degrees, so that a full angle corresponds to 360 degrees. An angle of less than ¼ full angle is interpreted as an acute angle. An angle of greater than ¼ and less than ½ full angle is interpreted as an obtuse angle. An angle equal to ¼ full angle is identified as a right angle.

FIG. 1a shows a first embodiment of the configuration of the notional contour line of the crane boom in a transverse plane of the crane boom. In this respect the term transverse plane is used to identify a plane through which the longitudinal axis of the crane boom passes in orthogonal relationship. All crane booms according to the invention have an axis of symmetry s which is arranged in the transverse plane and in relation to which the contour line of the crane boom extends in the transverse plane in at least approximately mirror-image relationship. For the situation where the crane boom is of the same cross-sectional shape over a large part of or its entire longitudinal extent, that axis of symmetry s represents the straight section line of the transverse plane with the plane of symmetry extending along the longitudinal axis (median plane). In all embodiments the contour line intersects the axis of symmetry s at first and second intersection points S₁, S₂. The center point M arranged on the axis of symmetry s equidistantly relative to the first and second intersection points S₁, S₂ represents the position of half the height of the crane boom in the transverse plane. Starting from the center point M in the direction of the intersection point S₂, that affords a region of the crane boom which, in operation, is predominantly subjected to a tensile loading. The region of the crane boom, that is between the center point M and the first intersection point S₁, is substantially subjected to a compression loading in operation.

The configuration of the contour line of the crane boom shown in FIG. 1 has four portions k₁, g₁, g₂, g₃ which can be distinguished from each other.

The portion k₁ which is arranged in the region of the compression loading that is greatest in operation is of an arcuate configuration since, as is known per se, that cross-sectional shape has reduced compression stresses and involves a reduction in the risk of buckling. It is sufficient if that portion is at least approximately arcuate in the sense that it can be approximated by a polygon, as is shown in FIGS. 1b and 1c. Approximation of the arcuate portion k₁ by a polygon permits easier manufacture by folding of the metal sheets forming the crane boom. It will be appreciated however that an arcuate configuration can be implemented by means of a rolling operation.

The arcuate portion k₁ can also be only approximately arcuate in the sense that it can be formed for example by one or more ellipse portions of suitably slight eccentricity. It would also be possible to envisage a configuration for the arcuate portion k₁ by arranging in joining relationship suitably short straight, elliptical and/or arcuate segments.

As shown in FIG. 1 it is particularly advantageous if the arcuate portion k₁ is in the form of a quarter-circle arc, that is to say it extends over an angle of about 90 degrees. It is possible in that way for the large part of the configuration of the contour line between the first intersection point S₁ and the point M to be produced in the form of an arcuate portion k₁. The variant shown in FIG. 1 is particularly preferred, in which the center point of curvature K of the arcuate portion k₁ is in the proximity of or on the axis of symmetry s and the center point of curvature K of the arcuate portion k₁ is between the first intersection point S₁ and the center point M.

It is provided in accordance with the invention, as shown in FIG. 1, that a second straight portion g₂ tangentially adjoins the arcuate portion k₁ in the direction of the first intersection point S₁, the second portion including an angle γ of less than 90 degrees with the axis of symmetry s (here the angle γ is about 72 degrees). That affords good weldability of the crane boom, better suitability for clamping for the welding operation by virtue of the portions which meet each other inclinedly and the possibility of producing a longitudinal weld seam without additional edge preparation. Overall that affords a configuration which is more reliable in terms of process implementation.

The angle is preferably less than 80 degrees. Preferably the angle γ is greater than 70 degrees.

In the FIG. 1 embodiment the center point of curvature K of the arcuate portion k₁ is disposed directly on the axis of symmetry s between the center point M and the first intersection point S₁. Unlike the situation shown the center point of curvature K can also be arranged displaced somewhat relative to the axis of symmetry s. It should however always be in the region between the center point M and the first intersection point S₁.

The first straight portion g₁ adjoins the arcuate portion k₁ in the direction of the second intersection point S₂ tangentially to the auxiliary circle illustrated in FIGS. 1a and 1b, the first portion g₁ extending over the large part of the contour configuration between the center point M and the second intersection point S₂. That straight configuration which is extended in length in the upper region of the crane boom and the resulting narrowing in cross-section forms a zone which is better suited than in the state of the art to carrying the tensile forces occurring here and the bearing and reaction forces which occur when arranged in a jib system. The notional extension g₁′ of the straight portion g₁ (see FIG. 1b) includes with the axis of symmetry s an acute angle β which in the illustrated embodiment is about 18 degrees. Quite generally the acute angle β can also be in a range of greater than 10 degrees, preferably greater than 15 degrees. In that respect an upper limit of 25 degrees is preferred in each case in order to exclude an excessively shallow configuration in respect of the straight portion g₁.

In the embodiment shown in FIG. 1 a third straight portion g₃ directly adjoins the first straight portion g₁, the third portion g3 extending as far as the axis of symmetry and intersecting it at the second intersection point S₂. As can be seen in particular in FIG. 1c, for reasons relating to manufacturing technology it may be desirable if the third straight portion g₃ (unlike the situation shown in FIG. 1a) is connected to the first straight portion g₁ not directly but by way of a preferably curved further portion.

In the FIG. 1 embodiment the third straight portion g₃ includes with the axis of symmetry s an angle α which is smaller than 90 degrees (in the FIG. 1 embodiment the angle α is about 65 degrees). A range for the angle α of less than 70 degrees is particularly preferred. The angle α in this embodiment should however be larger than 60 degrees.

In a further embodiment as shown in FIG. 2 the second straight portion includes a right angle with the axis of symmetry s.

The third straight portion g₃ affords the advantage that this arrangement, in the region around the tip of the crane boom, permits favorable local application of forces, as occurs for example when supporting slide packets between individual jib extensions. More specifically the short limb length affords a favorable relationship between the sheet metal thickness and the limb length so that deformation of the crane boom is prevented in the upper region.

It will be noted however that basically it would also be possible for the contour configuration in that region to be in the form of a second arcuate portion k₂ (see FIG. 3). That however only represents a special variant of a more general idea, namely the idea that the contour line ends in a rounded configuration at the line of symmetry s. As an alternative to the illustrated configuration of the rounded configuration in the form of an arcuate portion k₂ the rounded configuration could for example also be in the form of an edge configuration 7.

Quite generally it must be said in relation to all illustrated configurations that the centroid F of the area enclosed by the contour line in the transverse plane lies in a region between the center point M and the first intersection point S₁, that is to say below half the height of the crane boom. That provides that the cross-section concentration of the crane boom is displaced as much as possible downwardly into the compression zone, thereby affording a lower compression stress component.

As can be seen from the Figures the contour line of all embodiments has, between the first intersection point S₁ and the second intersection point S₂, an extreme point E at maximum distance e from the axis of symmetry S. The spacing D between the first intersection point and the second intersection point S₁, S₂ can in that case be at least twice as great as the distance e. Preferably the spacing D is at least two and a half times as great, particularly preferably 2.75 times as great, as the distance e. The spacing D can be in each case less than three times the distance e.

It can be provided that the spacing d of the contour line from the axis of symmetry s, at approximately a quarter of the spacing D between the first and second intersection points S₁, S₂, starting from the second intersection point S₂, is less than or equal to 0.8 times the maximum distance e.

In the FIG. 1 embodiment the extreme point E is between the center point M and the first intersection point S₁ approximately at the height of the center point of curvature K. In the FIG. 1a configuration the contour line has only one single extreme point E, that is to say the width of the crane boom decreases both in the direction of the first intersection point S₁ and also in the direction of the second intersection point S₂, starting from the extreme point E. When the arcuate portion k₁ is approximated by a polygonal line, as shown in FIG. 1c, it will be appreciated that all points on the polygonal portion, by which the arcuate portion k₁ is approximated in the region of the extreme point E, involve that maximum distance e.

Starting from the auxiliary circle shown in FIG. 1a, of the radius r, the embodiment of FIG. 1 involves a profile width b in accordance with b˜2r, a profile height D in accordance with D˜3r and a profile width upward b₁ in accordance with b₁˜r. Those particularly advantageous dimensions can be provided quite generally in crane booms according to the invention.

FIG. 1e shows for the embodiment of FIG. 1 the position of the centroid F between the center point M and the first intersection point S₁ on the axis of symmetry s. In this case the centroid F refers to the area shown in dash-dotted lines in FIG. 2, that is to say the entire area enclosed by the notional contour line (corresponds to the outside contour).

FIG. 1f shows a jib system 5 with a jib extension, showing in addition the mounting of the jib system 5 by way of a mounting element 1 and mounting of the jib extension in the jib by way of mounting elements 2. It will be appreciated that the illustrated embodiment is intended purely by way of example in relation to the number of illustrated jib extensions. The same mounting elements can be used in jib systems having any number of jib extensions.

The embodiment of FIG. 1g shows two crane booms which involve for example a jib extension arranged in a jib. It is of significance that the arcuate portion k₁ is approximated by different polygons. The inwardly disposed cross-sectional profile has fewer edges in the region of the arcuate portion, which can be of advantage in particular when dealing with small profiles, in terms of manufacturing technology.

Production of a crane boom according to the invention can be effected for example in such a way that the crane boom is formed from two shells which are shaped in mirror image relationship with each other, wherein one of the shells respectively corresponds to one of the embodiments. The two shells can be joined together, for example welded, in the region of the first intersection point S₁ and the second intersection point S₂.

It will be noted however that it is particularly preferably provided that the crane boom is produced from a single metal sheet at least along a portion of its longitudinal extent, the metal sheet being suitably shaped and then closed along a single line (for example by welding). That line can extend for example in the region of the first intersection point S₁ or the second intersection point S₂.

Shaping of the metal sheets can be effected in known manner or by folding or bending and/or rolling, and for example welding.

If different gauges are required, the outside contour should preferably remain the same and the sheet metal thickness should be applied inwardly.

FIG. 4 shows by way of example a jib system 5 having a jib extension arranged in a jib.

FIG. 5 shows by way of example a utility vehicle 3 on which a crane 4 according to the invention is arranged. The crane 4 has a jib system 5 according to the invention, in which case the individual jib extensions can be telescopically displaced relative to each other by way of thrust cylinders 6. It will be appreciated that telescopic displaceability can also be ensured by other drive means. A loading structure (not shown) could be arranged for example in the rearward region of the utility vehicle 3.

1. A crane boom for a crane having a longitudinal axis and a notional contour line extending in a transverse plane relative to an axis of symmetry in at least approximately mirror-symmetrical relationship, wherein the contour line has between a center point arranged on the axis of symmetry equidistantly relative to the first and second intersection points and the first intersection point an at least approximately arcuate portion which is tangentially adjoined in the direction of the second intersection point by a first straight portion whose notional extension in the direction of the second intersection point intersects the axis of symmetry and includes an acute angle therewith, characterised in that tangentially adjoining the approximately arcuate portion in the direction of the first intersection point is a second straight portion which extends to the axis of symmetry and includes therewith an angle of less than 90 degrees at the first intersection point in the interior of the area enclosed by the contour line.

2. A crane boom as set forth in claim 1 wherein the angle is less than 80 degrees.

3. A crane boom as set forth in claim 1 wherein the angle is greater than 70 degrees.

4. A crane boom as set forth in claim 1 wherein the notional extension includes an acute angle with the axis of symmetry.

5. A crane boom as set forth in claim 1 wherein the arcuate portion is in the form of a quarter-circle arc.

6. A crane boom as set forth in claim 1 wherein the center point of curvature of the arcuate portion is on or in the proximity of the axis of symmetry.

7. A crane boom as set forth in claim 1 wherein the center point of curvature of the arcuate portion is between the first intersection point and the center point.

8. A crane boom as set forth in claim 1 wherein the straight portion is in the form of a tangential extension of the arcuate portion.

9. A crane boom as set forth in claim 1 wherein the contour line between the first intersection point and the second intersection point has an extreme point at maximum distance from the axis of symmetry.

10. A crane boom as set forth in claim 9 wherein the spacing between the first and second intersection points is at least twice as great as the maximum distance of the extreme point from the axis of symmetry.

11. A crane boom as set forth in claim 9 wherein the extreme point is between the first intersection point and the center point which is arranged equidistantly in relation to the first and second intersection points.

12. A crane boom as set forth in claim 9 wherein the spacing of the contour line from the axis of symmetry at approximately a quarter of the spacing between the first and second intersection points starting from the second intersection point is less than or equal to 0.8 times the maximum distance.

13. A crane boom as set forth in claim 1 wherein the arcuate configuration is approximated by a polygon.

14. A crane boom as set forth in claim 1 wherein the crane boom is of the same cross-sectional shape at least over a large part of its longitudinal extent.

15. A crane boom as set forth in claim 1 wherein the crane boom comprises at least one metal sheet and the metal sheet thickness of all portions of the crane arm in the transverse plane is at least substantially equal in magnitude.

16. A crane boom as set forth in claim 1 wherein the crane boom comprises two shells which are shaped in mirror-image relationship with each other and are joined to each other—preferably in the region of the first intersection point and the second intersection point.

17. A crane boom as set forth in claim 1 wherein the crane boom at least along a portion of its longitudinal extent comprises a single metal sheet which is closed along a single line which extends preferably in the region of the first intersection point or the second intersection point.

18. A jib system for a crane wherein at least one jib and/or jib extension is in the form of a crane boom as set forth in claim 1.

19. A jib system as set forth in claim 18 wherein between one and twenty, preferably between five or ten, jib extensions are provided.

20. A jib system as set forth in claim 18 wherein more than five jib extensions are provided.

21. A jib system as set forth in claim 18 wherein the shapes of the contour line of the jib and the contour lines of all jib extensions are the same—possibly except for the degree of approximation of circular arcs by polygons.

22. A crane, in particular a loading crane, comprising a crane boom as set forth in claim 1.

23. A utility vehicle having a crane as set forth in claim 22.

24. A crane, in particular a loading crane, comprising a jib system as set forth in claim 18.
